(19) United States
(12) Patent Application Publication
(10) Pub. No.: US 2009/0019765 A1
(43) Pub. Date: Jan. 22, 2009

(54) PLANT GROWTH MEDIUM

(75) Inventors: Leonard KOSINSKI, Woodstock, GA (US); Eric SENDERS, Beachwood, OH (US); Cary SENDERS, University Heights, OH (US)

Correspondence Address: CURATOLO SIDOTI CO., LPA, 24500 CENTER RIDGE ROAD, SUITE 280, CLEVELAND, OH, 44145, US

(73) Assignee: 6062 Holdings, LLC, Beachwood, OH (US)

(21) Appl. No.: 12/175,654

(22) Filed: Jul. 18, 2008

Related U.S. Application Data
(60) Provisional application No. 60/950,472, filed on Jul. 18, 2007.

(51) Int. Cl. A01G 9/10; A01G 31/00

(52) U.S. Cl. 47/64; 428/357; 428/364; 428/369; 47/65.8; 47/56; 47/77; 47/62 R; 705/1

(57) ABSTRACT

Provided is an artificial plant growth medium that is useful as a substitute for naturally produced soil in supporting plant growth. The artificial plant growth medium includes a cohesive mass of polymer fiberballs. The artificial plant growth medium may include a cohesive mass of fiberballs that are composed of biodegradable and/or non-biodegradable polymer fibers for use in plant cultivation. The artificial plant growth medium provides the optimal balance of water, and air to support plant growth.

### CROSS REFERENCE TO RELATED APPLICATIONS

This application claims the benefit of the filing date under 35 U.S.C. 119(e) of U.S. Provisional Application For Patent Ser. No. 60/950,472 filed Jul. 18, 2007, which is hereby incorporated by reference in its entirety.

### TECHNICAL FIELD

Provided is a plant growth medium for use in plant cultivation as substitute for conventional plant growth media. More particularly, provided is a plant growth medium that includes a cohesive mass of polymer fiberballs useful for supporting plant growth.

### BACKGROUND

U.S. Pat. Nos. 6,397,520 and 6,555,219 disclose inventions designed to provide methods of supporting plant growth which provide a plant growth medium that, upon the addition of water and appropriate nutrients, can be used for the germination of seeds and growth of seedlings, the vegetative propagation and growth of other plant material, and the growth of plants to maturity or some other stage of growth and development. Furthermore, these inventions provide methods of supporting plant growth by providing a plant growth medium that can be used to replace all or a substantial amount of conventional materials, substantially improving total water holding ability and maintaining a more optimal balance between solids, water, and gases. The plant growth media of U.S. Pat. Nos. 6,397,520 and 6,555,219 are comprised of loose polymer fiberballs where the cohesive forces between the fiberballs is less than 15 Newtons.

A further purpose of the plant growth media of U.S. Pat. Nos. 6,397,520 and 6,555,219 is to provide a method of supporting plant growth which provides a plant growth medium that can be biodegradable to serve as a soil substitute or a soil supplement for starting seedlings to be transplanted to fields. Such a medium would exhibit considerable water retention and high property retention for a period of time prior to transplanting, but would after a certain period of time thereafter be sufficiently degraded to be “plowed under.”

In the conventional cultivation of plants, regardless of being indoor or outdoor, naturally produced soil has been used as the medium for storing and supplying the nutrients, air, and moisture necessary for raising plants. It is now well known in the art that artificial media can be used for the germination, rooting and propagation of plants. Media such as peat moss, vermiculite, perlite, wood bark, coir, sawdust, certain types of fly ash, pumice, plastic particles, glass wool, rock wool, and certain polymer-based foams are commonly used either alone or in various combinations with each other and/or natural soil.

Although these prior art media are useful and have achieved commercial acceptance in many areas, they do not provide an optimal balance between water and the gases that can significantly influence root and total plant growth. It is well known that plants growing in such commonly used media identified above can, under some conditions, suffer from lack of oxygen or show symptoms commonly believed to be caused by over-watering, i.e., chlorosis, slow growth, pale color, and even death. Furthermore, many of the peat bogs from which peat moss is harvested are being exhausted.

In view of the shortcomings of the prior art, there remains a great need for an improved artificial plant growth medium that can be used alone or in combination with other known artificial plant growth media and/or natural soil, which provides the optimal balance of water, gases and nutrients to support plant growth. The loose fiberballs of U.S. Pat. Nos. 6,397,520 and 6,555,219 function as plant growth mediums, but present materials handling challenges. Loose fiberballs require more labor to use than most conventional plant growth mediums. Loose fiberballs cannot be poured to fill a planter pot or tray, rather the loose fiberballs need to be added by the handful then poked and prodded to fill a desired shape.

### SUMMARY

Provided is a plant growth medium comprising a mass of polymer fiberballs and a cohesion promoter, wherein the cohesion forces between the fiberballs of said mass of fiberballs exceeds 15 Newtons. The present plant growth medium comprising a cohesive mass of fiberballs overcomes the handling problems of loose fiberballs, and the fused fiberball shapes provide labor savings relative to conventional plant growth media. Surprisingly and unexpectantly, the fused fiberball shapes still function as a plant growth medium.

Also provided is a method of cultivating plant growth, the method comprising contacting plant material with a plant growth medium comprising a mass of fiberballs and a cohesion promoter, wherein the cohesion forces between the fiberballs of said mass of fiberballs exceeds 15 Newtons.

### BRIEF DESCRIPTION OF THE DRAWINGS

FIG. 1A is a side perspective view of a cohesive mass of fiberballs formed into a continuous strip of plant growth medium.

FIG. 1B is a top view of a cohesive mass of fiberballs formed into a continuous strip of plant growth medium.

FIG. 2A is a top view of an illustrative embodiment of a cohesive mass of fiberballs formed into a continuous strip of plant growth medium.

FIG. 2B is a side perspective view of an illustrative embodiment of a cohesive mass of fiberballs formed into a continuous strip of plant growth medium.

FIG. 2C is an exploded view of an illustrative embodiment of a cohesive mass of fiberballs formed into a continuous strip of plant growth medium that is adapted to be positioned within a conventional plant growth tray.

FIG. 2D is a perspective view of an illustrative embodiment of a cohesive mass of fiberballs formed into a continuous strip of plant growth medium that is positioned within a conventional plant growth tray.

FIG. 3A is a top view of a cohesive mass of fiberballs formed into a continuous strip of plant growth medium having a plurality of separable units.

FIG. 3B is a side view of FIG. 3A, which is a cohesive mass of fiberballs formed into a continuous strip of plant growth medium having a plurality of separable units, and being attached to a substrate.

FIG. 4 is a top view of an illustrative embodiment of the a shape of plant growth material comprised of a cohesive mass of fiberballs.

FIG. 5A is a to perspective view of an illustrative cube composed of a cohesive mass of fiberballs positioned within a larger shape of the plant growth material comprised of a cohesive mass of fiberballs.

FIG. 5B is a side view of an illustrative embodiment of the plant growth medium showing multilayers of the plant growth medium comprising a cohesive mass of fiberballs and a space for accepting a separable shape of the plant growth medium in one of the layers.

FIG. 5C is a side view of an illustrative embodiment of the plant growth medium showing a continuous layer of the plant growth medium comprising a cohesive mass of fiberballs and a space for accepting a separable shape of the plant growth medium.

FIG. 6A is a perspective view of plant material in contact with an illustrative cube of plant growth material comprising a cohesive mass of polymer fiberballs.

FIG. 6B is a perspective view of plant material in contact with an illustrative cube of plant growth material comprising a cohesive mass of polymer fiberballs.

### DETAILED DESCRIPTION

An artificial plant growth medium is provided. The artificial plant growth medium includes a mass of polymer fiberballs and a cohesion promoter. The combination of the polymer fiberballs and the cohesion promoter provides a cohesive mass of polymer fibers exhibiting cohesion forces between the fiberballs of said mass of fiberballs that exceeds 15 Newtons. Also disclosed is a method of supporting plant growth. The method of supporting plant growth includes contacting a plant material with a plant growth medium comprising a cohesive mass of fiberballs in an amount effective to support plant growth.

At least a portion of the fiberballs comprising the cohesive mass of fiberballs comprises randomly-arranged, entangled, crimped polymer fibers. The polymer fibers that are useful in the preparation of the plant growth medium may comprise hollow or solid fibers and are generally made from polymer fibers in staple form having various cut lengths. The polymer fibers for use in the plant growth medium generally may be staple fibers having a cut length, without limitation, in the range of about 0.5 mm to about 60 mm. The polymer fibers may comprise a single polymer component or more than one polymer component (e.g., bi-component or conjugate fibers).

The polymer fibers that are used in preparing the fiberballs of the plant growth medium may be crimped. By way illustration, and not in limitation, spirally crimped fibers, i.e., those fibers having a three-dimensional helical crimp may be used to prepare the fiberballs. Such crimping may be carried out by asymmetric jet-quenching of freshly-extruded filaments, as disclosed U.S. Pat. Nos. 3,050,821 and 3,118,012, incorporated by reference herein. Spiral crimping of the polymer fibers may also be carried out the method disclosed in U.S. Pat. No. 3,671,379, which is also incorporated by reference herein.

According to certain illustrative embodiments, the spiral crimps may be in the form of an omega-crimp, as disclosed in U.S. Pat. No. 4,783,364, incorporated by reference herein.

The polymer fibers may also be provided with a two-dimensional saw-tooth crimp. The two-dimensional saw-tooth crimp may be imparted to the polymer fiber by mechanical means, such as a stuffer box.

The majority of polymer fibers including the case of all of the polymer fibers are used herein in the form of fiberballs. The term “fiberball” refers to a plurality of polymer fibers which have been formed into substantially rounded bodies. Without limitation, the fiberballs may have an average dimension of about 1 to about 15 mm, at least 50% by weight of the fiberballs having a cross-section such that its maximum dimension is not more than twice its minimum dimension. Polymer fibers in the shape of small, flattened discs mixed with larger cylindrical shapes (referred to as tails) may also be useful and are included in the definition of fiberball.

There are a variety of methods for preparing the fiberballs including, for example, by carding, agitating, rolling, and/or tumbling. Crimped fibers interlock to form very low density fiberballs having an essentially permanent structure. According to certain illustrative embodiments, without limitation, a particularly suitable fiberball is formed in accordance with the processes disclosed in U.S. Pat. Nos. 4,618,531 and 4,783,364 which are incorporated by reference herein. These processes involve repeatedly air-tumbling small tufts of fiber against the wall of a vessel. Generally, any machine capable of agitating fibers to render them stably entangled can be used to prepare fiberballs useful in the present plant growth medium.

The polymer fibers of the fiberballs may comprise natural fibers, synthetic fibers, or combinations of natural and synthetic fibers. According to certain embodiments, the polymer fibers may comprise a combination of more than one type of natural fiber. According to additional embodiments, the polymer fibers of the fiberballs may comprise a combination of one type of natural fiber and one type of synthetic fiber. According to additional embodiments, the polymer fibers of the fiberballs may comprise a combination of more than one type of natural fiber and one type of synthetic fiber. According to other embodiments, the polymer fibers of the fiberballs may comprise one type of natural fiber and more than one type of synthetic fibers. According to further embodiments, the polymer fibers may comprise a combination of more than one type of natural fiber and more than one type of synthetic fiber. According to further embodiments, the polymer fibers may comprise a combination of more than one type of synthetic fiber.

Various types of natural and synthetic organic polymer fibers are suitable for preparation of the fiberballs. As used herein, the term “synthetic organic polymer fibers” includes fibers prepared from polymers such as polyesters; polyacrylonitrile; polyvinyl alcohol; polyolefins; polyamides, such as nylon; acrylics; polylactides; and the like; as well as polymers derived from cellulose via chemical modification, such as viscose rayon, cellulose acetate; and the like. According to certain embodiments, the synthetic organic polymers for making fiberballs include polyester fibers, polyamide fibers, or blends thereof. Blends or combinations of any of the foregoing synthetic organic polymers are also useful to prepare the fiberballs, for example, a blend of nylon and polyester fibers. A particularly suitable synthetic organic polymer fiber used to prepare the fiberballs of the plant growth medium is polyethylene terephthalate.

Natural organic polymer fibers may also be used to prepare the fiberballs, either alone or in combination with synthetic organic polymer fibers. The term “natural organic polymers” includes, without limitation, polymers such as wool, cotton, jute, silk, hemp, bagasse, cellulose, and blends thereof. Also included in the term “natural organic polymers” are the polyhydroxyalkanoates fibers produced by bacteria or in plant seeds, such as polyhydroxybutyrate, polyhydroxyvalerate, and the like as well as copolymers thereof. Particularly suitable natural organic polymer fibers include cotton, cellulose, bagasse, and hemp. A particularly suitable natural organic polymer fiber used to prepare the fiberballs of the present invention is cellulose that has been dissolved in a solvent and spun into lyocell fibers.

Both biodegradable and non-biodegradable organic polymers are suitable for the polymer fiber useful in the preparation of the fiberballs of the plant growth medium. Non-biodegradable fibers include certain polyesters, polyamides, polyolefins, acrylics, polyacrylonitrile, and blends thereof. According to certain embodiments, the non-biodegradable polymers include polyester, polyamide, or blends thereof. Particularly suitable non-biodegradable polymer fibers are a poly(ethylene terephthalate) fibers. Such fiberballs are particularly suitable in situations where biodegradability is not required, such as for use with house plants and the like.

Biodegradable fibers include certain synthetic fibers such as various polyesters, polylactides, polyvinyl alcohol, chemically modified cellulose (e.g., viscose rayon and cellulose acetate), fibers from naturally produced polymers such as lyocell and polyhydroxyalkanoates, and natural fibers such as wool and cotton. A suitable biodegradable fiber is polyester, such as a polyester comprising a copolymer of poly(ethylene terephthalate) and diethylene glycol or a non-aromatic diacid, such as adipic acid or glutaric acid, and an alkali metal or alkaline earth metal sulfo group, such as 5-sulfoisophthalic acid or a metal 5-sulfoisophthalic acid derivative, as disclosed in U.S. Pat. Nos. 5,053,482; 5,097,004; 5,171,308; 5,171,309; 5,219,646; and 5,295,985, incorporated by reference herein. Such suitable fibers are commercially available from E. I. du Pont de Nemours and Company (Wilmington, Del.) under the registered trademark BIOMAX. Such biodegradable fiberballs comprise polyester fibers of a copolymer of poly(ethylene terephthalate) and diethylene glycol or a non-aromatic diacid, and an alkali metal or alkaline earth metal sulfo group. Suitable polylactic acid polymer and copolymer fibers are commercially available from Natureworks, LLC under the registered trademark INGEO. Suitable polyvinyl alcohol fibers are commercially available from Kuraray America Inc. (New York, N.Y.) under the tradename Kuralon. Suitable cellulose acetate fibers are commercially available from the Eastman Chemical Company (Kingsport, Tenn.). Suitable viscose rayon and lyocell fibers are commercially available from Lenzing Aktiengesellschaft (Lenzing, Upper Austria, Austria). Suitable polyhydroxybutyrate copolymers are commercially available from Metabolix (Cambridge, Mass.).

Also disclosed is a method for making a plant growth medium that comprises a cohesive mass of polymer fiberballs and a cohesion promoter. The method of making the plant growth medium comprises combining a plurality of fiberballs and a cohesion promoter adapted for thermal and/or adhesive bonding and forming the combination of the fiberballs and cohesion promoter into a desired shape. The use of a cohesion promoter provides cohesion forces between the fiberballs of the mass of fiberballs that exceeds 15 Newtons.

According to certain illustrative embodiments, the method of making the plant growth medium comprises combining a plurality of fiberballs and a cohesion promoter adapted for thermal bonding and forming the combination of the fiberballs and cohesion promoter into a desired shape. The cohesion promoter adapted for thermal bonding may be selected from meltable binders in fiber form, powder form and combinations thereof. The meltable binder may be provided as the outermost layer of a bi-component material, i.e. the sheath of a sheath-core fiber or as the shell of a shell-core powder. An important aspect of the meltable binder is that it has a bonding temperature lower than the softening temperature or degradation temperature of the fibers used to make the fiberballs. The meltable binder should have a melting temperature that is at least 20° C. lower than the melting point of the polymer fibers of the fiberballs. When preparing the cohesive mass of fiberballs for use as plant growth medium using a meltable binder, the amount of meltable binder can range from about 5 percent to about 50 percent, or 10 to 30 percent, by weight of the blend. The shape comprising the combination of polymer fiberballs and meltable binder is heated to a temperature sufficient to at least partially melt at least a portion of the meltable binder. In the cases of sheath-core binder fiber and shell-core binder powders, only the outermost layers (i.e., the sheath or shell) melt and the cores remain solid. The heated shape is then cooled to a temperature below the melting point of the meltable binder to affect the bonding of the cohesive mass of fiberballs.

The meltable binders used to thermally bond the plant growth medium comprised of fused fiberballs may be non-biodegradable or biodegradable, and may be man-made or naturally synthesized materials. Non-limiting examples of non-biodegradable, man-made meltable binders include polyolefins and so-called “low melt polyesters” (e.g., polyethyleneterephthalate-polyethyleneisophthalate copolymers). Non-limiting examples of man-made, biodegradable meltable binders include polylactides, polyvinylacetates, polyethylenevinylacetate, polyvinylalcohols, polyethylenevinylalcohols, polycaprolactone, and polyalkylethers. Non-limiting examples of naturally synthesized biodegradable meltable binders include the polyhydroxyalkanoates. The meltable binder materials can be of varied copolymer contents depending on the desired melting temperatures.

According to certain illustrative embodiments, the method of making the plant growth medium comprises a plurality of fiberballs that are themselves made containing a meltable binder fiber component. These fiberballs may be made from a physical mixture of non-binder staple fiber and meltable binder staple fiber. These fiberballs may be made from a physical mixture of non-binder staple fiber and a sheath-core staple fiber where the sheath serves as the meltable binder. These fiberballs may wholly be made from a sheath-core staple fiber where the sheath layer serves as the meltable binder. These fiberballs already containing a binder fiber component may be formed into a shape and heated to a temperature sufficient to at least partially melt at least a portion of the meltable binder fiber component. The heated shape is then cooled to a temperature below the melting point of the meltable binder fiber component.

According to certain illustrative embodiments, the method of making the plant growth medium comprises thermally bonding together two or more pieces of fiberballs already bonded into shapes. The interface(s) of the bonded fiberball shapes to be joined together may be treated with additional meltable binder fiber, meltable binder fibers in the form of a netting or web, and/or binder powder then contacted and held together and heated to a temperature sufficient to at least partially melt at least a portion of the meltable binder between the pieces. The heated shapes to be joined are then cooled to a temperature below the melting point of the meltable binder between the pieces resulting in their being bonded together.

According to certain illustrative embodiments, the method of making the plant growth medium comprises thermally bonding a shape comprised of a cohesive mass of fiberballs to another type of material. Non-limiting example of other types of materials are plastic films, plastic sheets, metal films, metal sheets, woven textiles, nonwoven textiles, airlaid textiles, knitted textiles, and the like. The interface of the bonded fiberball shape to be joined to the other material may be treated with additional meltable binder fiber, meltable binder fibers in the form of a netting or web, and/or binder powder then contacted and held together and heated to a temperature sufficient to at least partially melt at least a portion of the meltable binder between the bonded fiberball shape and the other material. The heated bonded fiberball shape and the other material to be joined are then cooled to a temperature below the melting point of the meltable binder between the two pieces resulting in their being bonded together.

According to certain illustrative embodiments, the method of making the plant growth medium comprises combining a plurality of fiberballs and a cohesion promoter adapted for adhesive bonding. The fiberballs may be formed into a desired shape, the adhesive binder applied as a liquid, and then the liquid adhesive binder made to set (i.e., dry or cure) to form the cohesive mass of fiberballs. The fiberballs and the adhesive binder in a solid form (e.g., fiber or powder) may be combined, the combination of fiberballs and solid adhesive binder formed into a desired shape, the adhesive binder activated by wetting with a liquid, and then active adhesive binder made to set (i.e., dry or cure) to form the cohesive mass of fiberballs. The cohesion promoter adapted for adhesive bonding may be, without limitation, selected from man-made materials such as polyvinylacetate, polyethylenevinylacetate, polyvinylalcohol, polyethylenevinylalcohol, polyalkylethers, their copolymers, and combinations thereof. The cohesion promoter adapted for adhesive bonding may be, without limitation, selected from naturally synthesized materials such as the natural gums, mixtures of unmodified and chemically modified starches, animal hide glues, animal hoof glues, and rabbit skin glue. The above-listed adhesive binders will employ water as the associated liquid to avoid volatile organic content (VOC) emissions during the adhesive setting process. However, if appropriate equipment is in place to handle VOC emissions, liquids other than water may be used as the associated liquid for the adhesive binder. For example, lyocell can be dissolved in an amine oxide solvent for use as an adhesive for lyocell fiberballs; or alternately, lyocell fiberballs can be wetted with the amine oxide solvent to make the fiberballs adhere to each other. Similarly, acetone may be used for the hydroxyalkanoate polymers.

Without limitation, the method for making a plant growth medium may comprise forming a plurality of fiberballs into a desired shape then combining with an adhesive in liquid form. The liquid adhesive binder can be a solution or an emulsion, and optionally can contain plasticizers and/or crosslinking agents for the adhesive binder. The shape comprising the combination of polymer fiberballs and liquid binder adhesive undergoes a setting process to set at least a portion of the adhesive to provide a plant growth medium wherein the cohesion forces between the fiberballs of plant growth medium exceeds 15 Newtons. If the adhesive binder is set by simple liquid removal, this is drying. If the adhesive binder is set by a combination of liquid removal and adhesive binder crosslinking, this is curing. By way of illustration, the method for making a plant growth medium comprises combining an amount of fiberballs with a polyvinylalcohol adhesive binder in water.

According to certain illustrative embodiments, the method of making the plant growth medium comprises combining a plurality of fiberballs and a cohesion promoter in solid form adapted for adhesive bonding and forming the combination of the fiberballs and cohesion promoter into a desired shape. If the solid adhesive binder is in fiber form, it may be used alone or along with other polymer fibers to make the fiberballs and these fiberballs formed into the desired shape. The adhesive binder in solid form (e.g., powder or fiber) may be combined with polymer fiberballs and formed into the desired shape. The fiberballs combined with the solid adhesive binder that are formed into a desired shape may then be wet with a liquid to activate the adhesive binder. The liquid used to activate the solid adhesive binder may optionally contain plasticizers and/or crosslinking agents. The shape comprising the combination of polymer fiberballs and activated adhesive binder then undergoes a setting process to set at least a portion of the adhesive to provide a plant growth medium wherein the cohesion forces between the fiberballs of plant growth medium exceeds 15 Newtons.

Without limitation, it is expected that a formed shape of fiberballs having a cohesive force between the fiberballs exceeding 15 Newtons may be bonded to another formed fiberball shape or other substrate using either the liquid or solid adhesive binder technologies.

The mass of fiberballs may be combined with a cohesion promoter that is adapted for either adhesive or thermal bonding of the fiberballs and formed into a desired shape selected from squares, rectangles, cubes, slabs, blocks, mats, pads, cylinders and the like. These shapes comprised of fiberballs having a cohesive force between the fiberballs exceeding 15 Newtons may be subjected to additional operations such as cutting, hole punching, sewing and the like.

Nutrients, fertilizers, fungicides, algaecides, weed killers, pesticides, hormones, bactericides, plant growth regulators, insecticides, combinations thereof, and the like may be included in the plant growth medium. Any known and commercially available plant fertilizers or nutrients may be included in the plant growth medium. Suitable fungicides include benomyl flusilazole and other triazoles (e.g., NUSTAR. sold by E. I. du Pont de Nemours and Company, metalaxyl and other acylalanines (e.g., RIDOMIL sold by Ciba-Geigy Corp.), and tridemorph and other morphlines (e.g., CALIXINE sold by BASF), among others.

Suitable insecticides include oxamyl and other related carbamates (e.g., VYDATE sold by E. I. dupont de Nemours and Company), acephate (e.g. ORTHENE sold by Chevron Chemical Co.), resmethrin and other pyrethrodis (e.g., SYNTHRINE sold by Fairfield American Corp.), among others.

Suitable herbicides include chlorsulfuron and other sulfonylureas (e.g., GLENA. sold by E. I. du Pont de Nemours and Company) among others. Combinations of fungicides, insecticides and fertilizers help protect young germinating seedling plants from disease and insect damage while supplying needed nutrients.

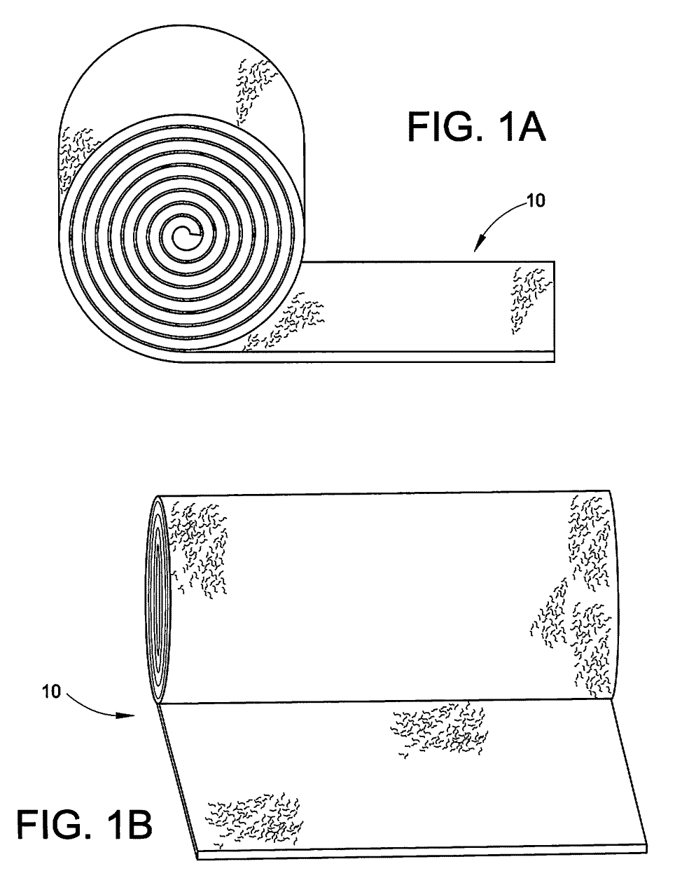

FIGS. 1A and 1B illustrate a roll of a strip or web of fiberballs combined with a cohesion promoter so as to have a cohesive force between the fiberballs exceeding 15 Newtons to form a continuous strip of plant growth medium 10.

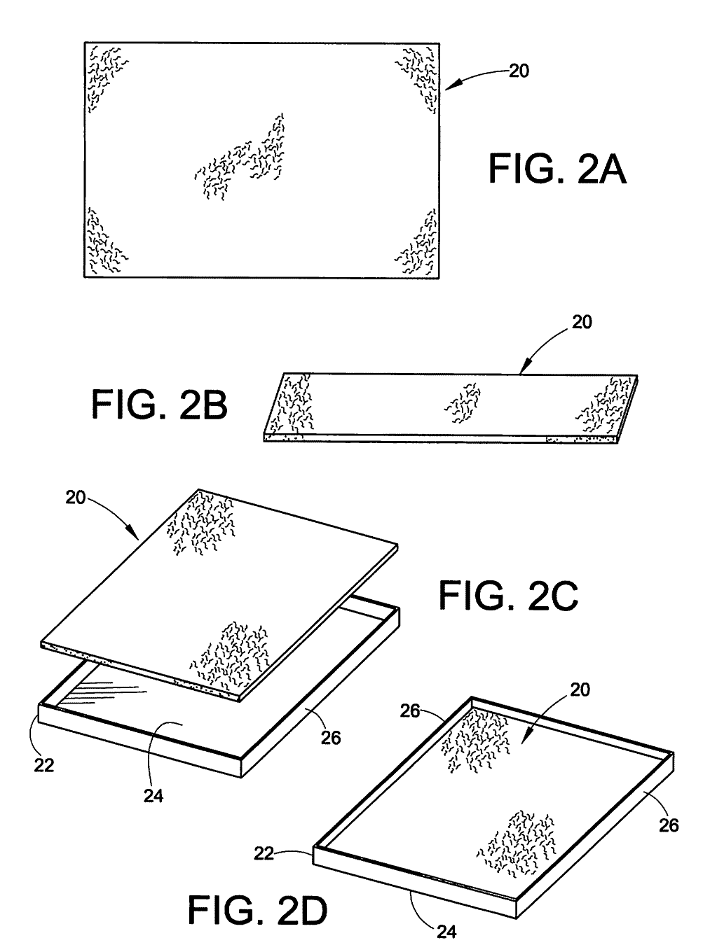

FIGS. 2A and 2B shows another illustrative embodiment of a cohesive mass of fiberballs formed into a continuous strip of plant growth medium 20 having a desired thickness. FIG. 2C is an exploded view of illustrative embodiment 20 of a cohesive mass of fiberballs formed into a continuous strip of plant growth medium that is adapted to be positioned within a conventional plant grow tray 22. Traditional grow tray 22 includes a bottom wall 24 and sides 26. The outer dimensions of plant growth material 20 are smaller than distances between side walls 26 of grow tray 22 such that the material can be easily positioned within the grow tray 22. FIG. 2D is a perspective view of illustrative embodiment 20 of a cohesive mass of fiberballs formed into a continuous strip of plant growth medium that is positioned within a conventional plant growth tray 22 adjacent bottom wall 24.

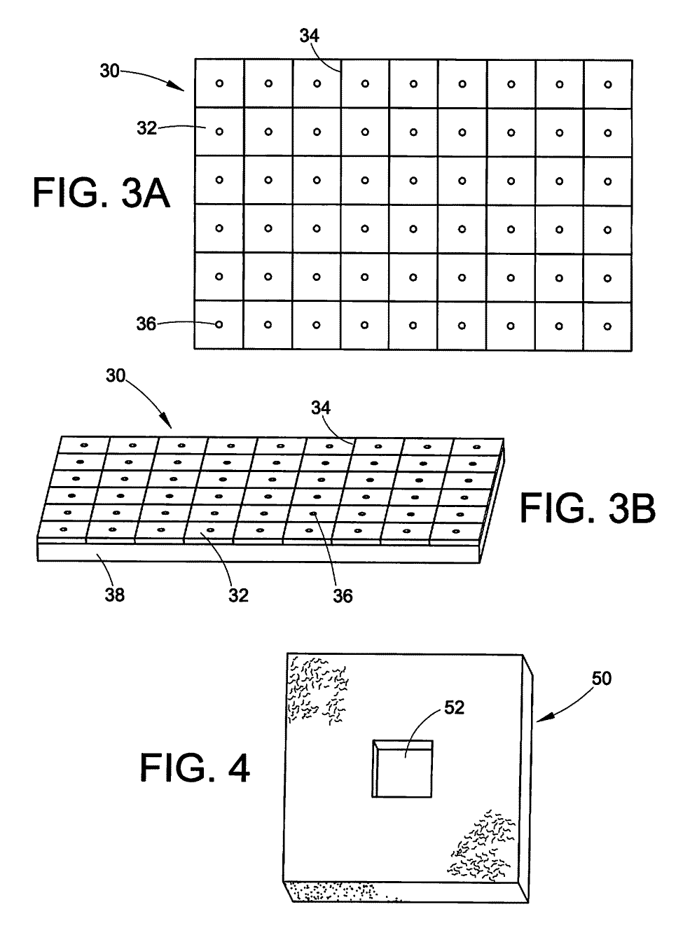

FIG. 3A is a top view of a cohesive mass of fiberballs formed into a continuous strip 30 of plant growth medium having a plurality of separable units 32. The strip or web 30 of fiberballs combined with the thermal binder fiber arranged into a grid-like shape, with punched perforations 34 dividing the strip 30 into a number of separable units, such as squares or rectangles 32. The punched perforations 34 are designed to allow for breaking the strip 30 into a plurality of substantially cube shaped components 32 of the fiberballs with the thermal binder fiber having a cohesion measurement between the fiberballs exceeding 15 Newtons. Within each component 32, there can be formed a cavity or slit of hole 36 formed partially into the thickness of the body of the component 32. This slit is designed to accommodate a seed or plant cutting.

FIG. 3B is a side view of FIG. 3A, which is a cohesive mass of fiberballs formed into a continuous strip 30 of plant growth medium having a plurality of separable units 32, such as cubes, and being attached to a substrate 40. Perforations 34 to facilitate separation of separable cubes 32 from strip 30 are shown. The cavity 36 is shown formed partially into the thickness of the body of the component 32.

FIG. 4 is a top view of an illustrative embodiment of a shape 50 of plant growth material comprised of a cohesive mass of fiberballs. Shape 50 of plant growth material includes cavity 52 formed within its thickness for accepting another separate shape of plant growth material.

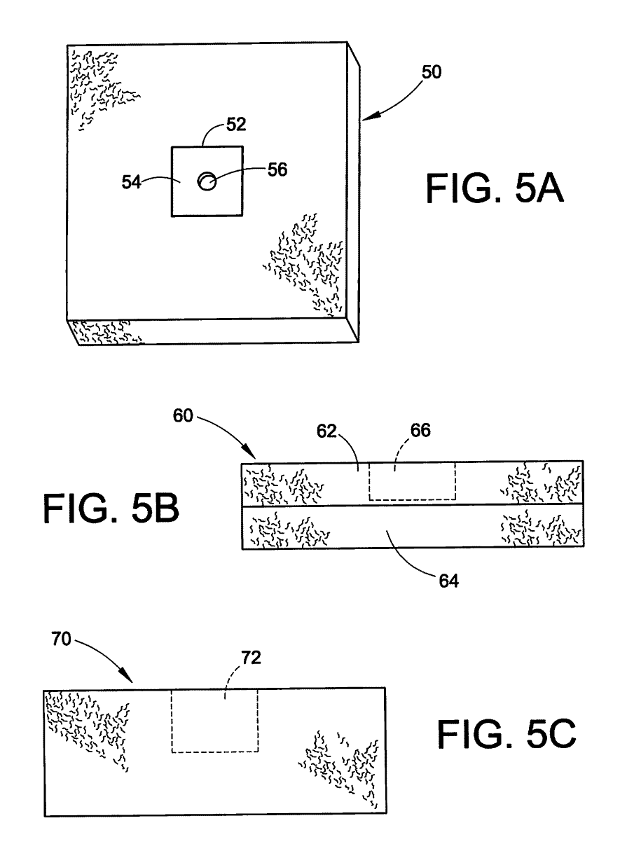

FIG. 5A is a to perspective view of an illustrative cube 54 composed of a cohesive mass of fiberballs that is positioned within the cavity 52, which specifically sized to receive cube 54, of the larger shape 50 of the plant growth material comprised of a cohesive mass of fiberballs. Cube 54 also includes cavity for accepting plant material 24. The larger shape 50 can also support growth of the plant material 24 as it gets larger.

FIG. 5B is a side view of an illustrative embodiment 60 of the plant growth medium. According to this embodiment, a layer 62 of plant growth material may be attached to a substrate 64. A cavity 66 for accepting a separable shape of plant growth material comprising a cohesive mass of fiberballs, is formed within at least a portion of the thickness of layer 62.

FIG. 5C is a side view of another illustrative embodiment of the plant growth medium showing a continuous layer 70 of the plant growth medium comprising a cohesive mass of fiberballs. A cavity 72 for accepting a separable shape of plant growth material comprising a cohesive mass of fiberballs, is formed within at least a portion of the thickness of layer 70.

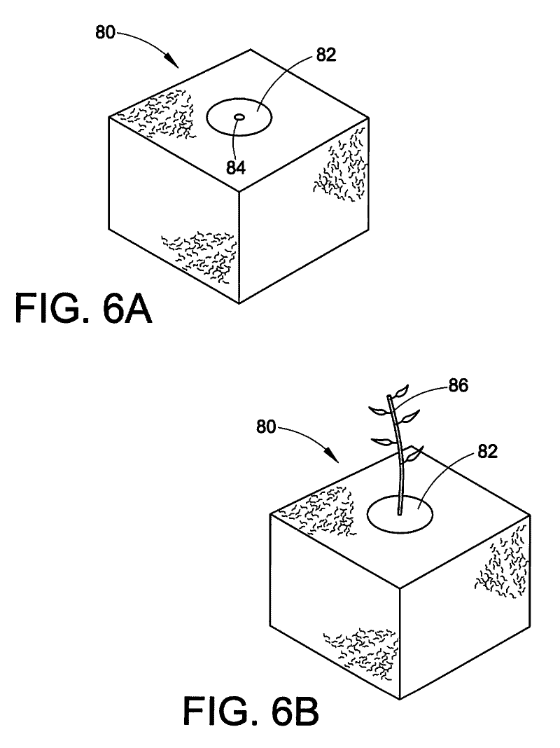

FIG. 6A is a three dimensional view of a unit 80, such as a cube, of plant growth material comprising a cohesive mass of fiberballs. Cube 80 includes a cavity 82. Positioned within cavity 82 is plant material in the form of a seed 84. FIG. 6B is a three dimensional view of a unit 80, such as a cube, of plant growth material comprising a cohesive mass of fiberballs. Cube 80 includes a slit or cut 82. Positioned within cavity 82 is a portion of plant material in the form of a plant cutting 86.

According to certain illustrative embodiments, the plant growth medium may further comprise at least one conventional plant growth medium. Suitable conventional plant growth media that may be included in the plant growth medium include, for example, natural soil, soil mixtures, vermiculite, sand, perlite, peat moss, clay, wood bark, coir, sawdust, fly ash, pumice, plastic particles, glass wool, rock wool, and polyurethane foams, and combinations thereof.

Because the polymer fibers of the plant growth medium may be colored, the method of making the plant growth medium may further comprise using colored (pigmented) fibers or contacting the fibers or fiberballs with a dye to impart a desired color. Thus, the plant growth medium may be used as an identification tool to distinguish between different types of plant material or crops, or even play a role in interior decoration.

Additionally disclosed is a method of supporting plant growth. The method of cultivating plant growth comprises contacting plant material with a plant growth medium comprising a mass of fiberballs and a cohesion promoter, wherein the cohesion forces between the fiberballs of the mass of fiberballs exceeds 15 Newtons. By “support” or “supporting” is meant that the plant growth medium assists in providing plant material with a means for subsisting. By “plant material” is meant seeds, germinated seeds, seedlings, sprouts, shoots, tubers, bulbs, plants, or any part of a plant capable of growth on its own, for example cuttings, or the like.

By “contacting” is meant placing the plant growth medium comprising fiberballs sufficiently close to the plant material to enable the plant growth medium to support plant growth. This can include spreading seeds or germinated seeds on top of the plant growth medium. The plant growth medium comprised of a cohesive mass of fiberballs provides a consistent flat surface upon which to sow seeds; in contrast, loose fiberballs provide an irregular surface with crevices that result in uneven seed deposition when sown. Seeds, seedlings and plant cuttings can be inserted into holes or slits in the plant growth medium. Seedlings along with the medium in which they are growing can be inserted into holes in the plant growth medium of this method. Bulbs can be set on top of the plant growth medium with their roots contacting the plant growth medium.

The amount of fiberballs used will vary depending on the type and size of the plant material and whether the plant growth medium further comprises one or more conventional plant medium. For example, the amount of fiberballs initially used to germinate a seed can be a layer only one or a few fiberballs thick. The plant growth medium permits good anchoring of the growing roots.

A problem with growing plants in pots, in other sorts of indoor growing containers, or even in fields is providing and maintaining adequate water and oxygen to the roots of the plant. In addition to providing adequate water and oxygen to the roots, the plant growth medium can exhibit many features and advantages, some of which may depend in part on the type of fiber selected for use in preparing the fiberballs used herein: resistance to decay or biodegradable, resistance to microbes, lightness, and a morphology and density particularly conducive to plant growth. The plant growth medium has very good moisture retention characteristics. For example, fiberballs prepared from polyethyleneterephthalate fibers typically absorb about 30 times their weight in water.

Because of its unique morphology, which exhibits from about 94% to about 98% air void, large quantities of air may be retained between the fiberballs, and thus the plant growth medium permits adequate amounts of oxygen to reach the roots. In addition, this morphology enables good thermal insulation to protect plant material from fluctuations in temperature.

Conventional plant growth media are watered from the top and kept out of excess water to prevent water wicking to their top surfaces. Water on the top surface of a plant growing media will often kill a seedling via a process known as “damp off.” Another highly useful attribute of the fiberballs is that for many of the polymer fiber types useful for the present method they do not appear to wick water to the surface, thus offering the potential to reduce evaporation losses. By not wicking water to their top surfaces, the fiberballs enable watering plants from the bottom. The structure of the fiberballs causes liquids to be retained close to plant roots. Such a quality promotes the growth of prosperous and well-developed plant root systems and enables the use of the present method in hydroponic systems. Non-limiting examples of food crops that may be grown with the cohesive mass of fiberballs include microgreens, herbs, wheatgrass, lettuce, spinach, cucumbers, squashes, melons, peppers, tomatoes, beans, onions, strawberries, and the like. The cohesive mass of fiberballs provides an advantage over other conventional plant growth mediums and loose fiberballs when certain crops are cut off for harvesting where the cohesive mass of fiberballs allows collection of the harvested plant materials without contamination by the growth medium.

The method of cultivating plant growth using the plant growth medium comprising a cohesive mass of polymer fiberballs may include contacting a plant material with the plant growth medium and aquaponically cultivating the plant material. The term “aquaponically” refers to cultivating plant material and aquatic animals in an integrated system. Aquatic animals, such as fish, located in an aquaculture digest food and excrete waste into the water of the aquaculture. The waste of the fish provides a nutrient source for the growing plant material. Instead of filtering and disposing, the nutrient-rich water is provided to the plant material. The plant material uptakes the nutrients from the waste water of the aquaculture, thereby reducing the toxic levels of waste in the water. The water is then recirculated to the aquatic animal environment.

The cohesive masses of fiberballs may be used in “precision farming.” By “precision farming” is meant a farming method wherein a seed, cutting or seedling is placed into the ground along with a precisely placed addition of nutrients, pesticides, etc. The advantage provided by precision farming is it avoids the surface application of agricultural chemicals that ultimately are washed away into the water table. Using the biodegradable fibers together with conventional plant growth material provides a convenient method for precision farming wherein the agricultural chemicals can be added together when making the cohesive mass of fiberballs or can be applied to the cohesive mass of fiberballs after the plant material is present within the cohesive mass of fiberballs.

Because plants can be cultivated without using any natural soil at all, the plant growth medium of the present method can be hygienic. Because certain embodiments of the plant growth medium of the present method are prepared from non-biodegradable fibers, the medium can be sterile and can be particularly suited for growing sensitive plants.

When prepared from non-biodegradable polymer fibers, the cohesive mass of fiberballs of the plant growth medium can be resistant to microbes and thus less susceptible to bacterial, viral, fungal and insect infestation. Thus, utilization of such plant growth medium would alleviate the need to use environmentally hazardous fungicides, insecticides or other infestation controlling chemicals and make more desirable distribution of plants marketed intact with root systems. For instance, wheatgrass, lettuce and microgreens may be shipped to stores, restaurants or consumers still growing in the cohesive mass of fiberballs to provide better freshness and greater longevity. Another advantage of the cohesive mass of fiberballs as plant growth medium is it can be shipped across international borders with plant materials unlike many conventional plant growth mediums which are explicitly banned.

The plant growth medium is particularly suitable for use as a growth medium for seed germination testing. Nurseries test seed germination rates and are confronted with the difficulty of finding consistent, reproducible growth media. Conventional growth media vary due to different points of origin as well as due to aging effects. For example, organic material such as peat moss degrades over time giving a higher acid content. The cohesive mass of fiberballs overcomes these difficulties by providing a more convenient, sterile, consistent growth medium for seed germination testing. Many seeds when spread onto the surface of the cohesive mass of fiberballs germinate more quickly than when germinated in or on conventional plant growth mediums.

The comparative light weight of the cohesive mass of fiberballs makes them especially suitable for cultivation in special regions, such as mountains or the coast, infertile natural environments, or urban areas. In the urban environment, the light weight of the cohesive mass of fiberballs makes them particularly suitable for cultivating plants in rooftop gardens, terraces, and balconies. Standing in marked contrast to comparatively heavy soil, the light weight of the cohesive mass of fiberballs also contributes to their ease of transport, and manipulation. Consequently, the back-breaking toil often associated with tilling and preparing farm land is avoided. In addition, the cohesive mass of fiberballs provide better air availability and higher water holding capacity than other lightweight synthetic soils such as those made of polystyrene foam. Further, the cohesive mass of fiberballs are safe to handle and can be stored substantially indefinitely.

With the growing demand for soil for plants used as decoration for room interiors and cultivated on balconies or rooftops, particularly urban areas, the present plant growth medium is useful in providing a plant growth medium as a soil substitute, including for hydroponic cultivation, as a soil supplement in flower pots, balcony planters, or in rooftop areas to cultivate plants, or as a supplement to other conventional plant growth media.

Accordingly, the plant growth medium, upon the addition of water and appropriate nutrients, can be used for the germination of seeds and growth of seedlings, the vegetative propagation and growth of other plant material, and the growth of plants to maturity or some other stage of growth and development.

Additionally, the plant growth medium may be used to replace all or a substantial amount of conventional materials such as normal soils, soil mixtures, clay, vermiculite, perlite, peat moss, bark, wood shavings or chips, coir, glass wool, rock wool, and the like, thus substantially improving total water holding ability and maintaining a more optimal balance between solids, water, and gases.

Furthermore, the plant growth medium may be biodegradable to serve as a soil substitute or a soil supplement for starting seedlings to be transplanted to fields. Such a medium would exhibit considerable water retention and high property retention for a period of time prior to transplanting, but would after a certain period of time thereafter be sufficiently degraded to be “plowed under” in a crop field.

The plant growth medium may be biodegradable to serve as a soil substitute for landscaping or vegetable garden plants intended for transplanting outdoors. Such a medium would exhibit considerable water retention and high property retention for a period of time prior to transplanting, but would provide the benefits of cleanliness and light weight during transport, and after transplanting outdoors in the soil would biodegrade after a certain period of time.

Also disclosed is a method of delivering live plant material to an intended destination. The method includes transporting the plant material growing in the plant growth medium comprising a cohesive mass of polymer fiberballs to an intended destination, such as a retail grocery store, restaurant or any other destination that would benefit from receiving live plant material and thereby maximizing the freshness of the plant material.

Further disclosed is a method of selling a live plant material to a buyer. The method comprises contacting a plant material a plant growth medium comprising a cohesive mass of polymer fiberballs, cultivating the plant material in the plant growth medium, and selling the growing plant material remaining in contact with at least a portion of the plant growth medium to a buyer.

While the plant growth medium, process for making the plant growth medium, process of cultivating plant material using the plant growth medium and other discloses processes have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the plant growth medium and processes should not be limited to any single embodiment, but rather construed in breadth and scope in accordance with the recitation of the appended claims.

1. A plant growth medium comprising a mass of polymer fiberballs and a cohesion promoter, wherein the cohesion forces between the fiberballs of said mass of fiberballs exceeds 15 Newtons.

2. The plant growth medium of claim 1, wherein the polymer fiberballs and cohesion promoter are non-biodegradable.

3. The plant growth medium of claim 1, wherein the polymer fiberballs and cohesion promoter are biodegradable.

4. The plant growth medium of claim 1, wherein the polymer fiberballs and cohesion promoter comprise a mixture of non-biodegradable and biodegradable materials.

5. The plant growth medium of claim 2, wherein said polymer fiberballs comprise polyethyleneterephthalate.

6. The plant growth medium of claim 3, wherein said polymer fiberballs comprise biodegradable copolyesters.

7. The plant growth medium of claim 3, wherein said polymer fiberballs comprise polylactic acid (PLA) polymer and copolymers thereof.

8. The plant growth medium of claim 3, wherein said polymer fiberballs comprise cellulosic polymers selected from lyocell, viscose rayon, cellulose acetate and mixtures thereof.

9. The plant growth medium of claim 3, wherein said polymer fiberballs comprise polyhydroxyalkanoates, polyhydroxyalkanoate copolymers, and mixtures thereof.

10. The plant growth medium of claim 3, wherein said polymer fiberballs comprise polymers selected from polyvinylacetate, polyvinlyalcohol, polyethylenevinylacetate, polyethylenevinylalcohol, and mixtures thereof.

11. The plant growth medium of claim 1, wherein sheath-core fibers are used.

12. The plant growth medium of claim 1, wherein said cohesion promoter is selected from the group consisting of thermal binder, adhesive binder, and combinations thereof.

13. The plant growth medium of claim 12, wherein said thermal binder exhibits a melting temperature that is at least 20° C. lower than the melting temperature of said fiberballs.

14. The plant growth medium of claim 1, wherein said cohesion promoter is selected from the group consisting of low melt polyester, polyolefins or other non-biodegradable thermal binder.

15. The plant growth medium of claim 1, wherein said cohesion promoter is selected from the group consisting of polylactic acid copolymers, polyhydroxyalkanoates, polyhydroxyalkanoate copolymers, polyvinylacetate, polyvinlyalcohol, polyethylenevinylacetate, polyethylenevinylalcohol, and mixtures thereof.

16. The plant growth medium of claim 1, wherein said cohesion promoter is selected from the group consisting of natural gums, starches, chemically modified starches, animal hide glue, animal hoof glue, rabbit skin glue and combinations thereof.

17. The plant growth medium of claim 1, wherein at least a portion of said fiberballs of said mass of fiberballs comprises randomly-arranged and entangled polymer fibers.

18. The plant growth medium of claim 17, wherein said randomly-arranged and entangled polymer fibers are crimped.

19. The plant growth medium of claim 17, wherein said polymer fibers have a cut length from about 0.5 to about 60 mm.

20. The plant growth medium of claim 1, wherein said mass of fiberballs further comprising a cavity or slit to accommodate a plant material.

21. The plant growth medium of claim 1, wherein said mass of fiberballs further comprising perforations to allow separation of pieces of the mass of fiberballs.

22. The plant growth medium of claim 1, wherein said mass of fiberballs is bonded to another mass of fiberballs.

23. The plant growth medium of claim 1, wherein said mass of fiberballs is bonded to a substrate.

24. The plant growth medium of claim 23, wherein said substrate is selected from the group consisting of plastic films, plastic sheets, metal films, metal sheets, woven textiles, nonwoven textiles and knitted textiles.

25. The plant medium of claim 1, further comprising one or more conventional plant media selected from the group consisting of natural soil, soil mixtures, vermiculite, sand, perlite, peat moss, clay, wood bark, coir sawdust, fly ash, pumice, plastic particles, glass wool, rock wool, polyurethane foams, and combinations thereof.

26. The plant growth medium of claim 1, further comprising at least one of nutrients, fertilizers, fungicides, algaecides, weed killers, pesticides, hormones, bactericides, plant growth regulators, insecticides, and combinations thereof.

27. A method of cultivating plant growth comprising contacting plant material with a plant growth medium comprising a mass of fiberballs and a cohesion promoter, wherein the cohesion forces between the fiberballs of said mass of fiberballs exceeds 15 Newtons.

28. The method of cultivating plant growth of claim 27, wherein the polymer fiberballs and cohesion promoter are non-biodegradable.

29. The method of cultivating plant growth of claim 27, wherein the polymer fiberballs and cohesion promoter are biodegradable.

30. The method of cultivating plant growth of claim 27, wherein the polymer fiberballs and cohesion promoter comprise a mixture of non-biodegradable and biodegradable materials.

31. The method of cultivating plant growth of claim 28, wherein said polymer fiberballs comprise polyethyleneterephthalate.

32. The method of cultivating plant growth of claim 29, wherein said polymer fiberballs comprise biodegradable copolyesters.

33. The method of cultivating plant growth of claim 29, wherein said polymer fiberballs comprise polylactic acid (PLA) polymer and copolymers thereof.

34. The method of cultivating plant growth of claim 29, wherein said polymer fiberballs comprise cellulosic polymers selected from lyocell, viscose rayon, cellulose acetate and mixtures thereof.

35. The method of cultivating plant growth of claim 29, wherein said polymer fiberballs comprise polyhydroxyalkanoates, polyhydroxyalkanoate copolymers, and mixtures thereof.

36. The method of cultivating plant growth of claim 29, wherein said polymer fiberballs comprise polymers selected from polyvinylacetate, polyvinlyalcohol, polyethylenevinylacetate, polyethylenevinylalcohol, and mixtures thereof.

37. The method of cultivating plant growth of claim 27, wherein sheath-core fibers are used.

38. The method of cultivating plant growth of claim 27, wherein said cohesion promoter is selected from the group consisting of thermal binder, adhesive binder, and combinations thereof.

39. The method of cultivating plant growth of claim 38, wherein said thermal binder exhibits a melting temperature that is at least 20° C. lower than the melting temperature of said fiberballs.

40. The method of cultivating plant growth of claim 27, wherein said cohesion promoter is selected from the group consisting of low melt polyester, polyolefins or other non-biodegradable thermal binder.

41. The method of cultivating plant growth of claim 27, wherein said cohesion promoter is selected from the group consisting of polylactic acid copolymers, polyhydroxyalkanoates, polyhydroxyalkanoate copolymers, polyvinylacetate, polyvinlyalcohol, polyethylenevinylacetate, polyethylenevinylalcohol, and mixtures thereof.

42. The method of cultivating plant growth of claim 27, wherein said cohesion promoter is selected from the group consisting of natural gums, starches, chemically modified starches, animal hide glue, animal hoof glue, rabbit skin glue and combinations thereof.

43. The method of cultivating plant growth of claim 27, wherein at least a portion of said fiberballs of said mass of fiberballs comprises randomly-arranged and entangled polymer fibers.

44. The method of cultivating plant growth of claim 43, wherein said randomly-arranged and entangled polymer fibers are crimped.

45. The method of cultivating plant growth of claim 43, wherein said polymer fibers have a cut length from about 0.5 to about 60 mm.

46. The method of cultivating plant growth of claim 27, wherein said mass of fiberballs further comprising a cavity or slit to accommodate a plant material.

47. The method of cultivating plant growth of claim 27, wherein said mass of fiberballs further comprising perforations to allow separation of pieces of the mass of fiberballs.

48. The method of cultivating plant growth of claim 27, wherein said mass of fiberballs is bonded to another mass of fiberballs.

49. The method of cultivating plant growth of claim 27, wherein said mass of fiberballs is bonded to a substrate.

50. The method of cultivating plant growth of claim 49, wherein said substrate is selected from the group consisting of plastic films, plastic sheets, metal films, metal sheets, woven textiles, nonwoven textiles and knitted textiles.

51. The method of cultivating plant growth of claim 27, further comprising one or more conventional plant media selected from the group consisting of natural soil, soil mixtures, vermiculite, sand, perlite, peat moss, clay, wood bark, coir sawdust, fly ash, pumice, plastic particles, glass wool, rock wool, polyurethane foams, and combinations thereof.

52. The method of cultivating plant growth of claim 27, further comprising at least one of nutrients, fertilizers, fungicides, algaecides, weed killers, pesticides, hormones, bactericides, plant growth regulators, insecticides, and combinations thereof.

53. The method of cultivating plant growth of claim 27, wherein said contacting plant material with a plant growth medium comprising contacting an ungerminated seed with said plant growth medium.

54. The method of cultivating plant growth of claim 27, wherein said contacting plant material with a plant growth medium comprising contacting a germinated seedling with said plant growth medium.

55. The method of cultivating plant growth of claim 27, wherein said contacting plant material with a plant growth medium comprising contacting a germinated seedling and the plant medium in which the seedling is growing with said plant growth medium.

56. The method of cultivating plant growth of claim 27, wherein said contacting plant material with a plant growth medium comprising contacting a plant cutting with said plant growth medium.

57. The method of cultivating plant growth of claim 27, wherein said method comprising contacting a plant material with said plant growth medium and hydroponically cultivating said plant material.

58. The method of cultivating plant growth of claim 27, wherein said method comprising contacting a plant material with said plant growth medium and aquaponically cultivating said plant material.

59. The method of cultivating plant growth of claim 27, comprising contacting plant material with said plant growth medium for a period of time and subsequently transplanting said plant material with said plant growth medium into a different plant growth medium.

60. The method of cultivating plant growth of claim 59, wherein said different plant growth medium comprises natural soil.

61. The method of cultivating plant growth of claim 27, comprising contacting plant material with a plant growth medium different from said plant growth medium of claim 27 for a period of time and subsequently transplanting said plant material by contacting said plant material and said different plant growth medium with said plant growth medium of claim 27.

62. The method of cultivating plant growth of claim 61, wherein said different plant growth medium comprises natural soil.

63. A method of delivering live plant material comprising transporting said plant material growing in the plant growth medium of claim 1 to an intended destination.

64. A method of selling a live plant material comprising contacting a plant material with the plant growth medium of claim 1; and selling the plant material in contact with said plant growth medium to a buyer.
